(19) United States
(12) Patent Application Publication
(10) Pub. No.: US 2012/0038748 A1
(43) Pub. Date: Feb. 16, 2012

(54) Vision System and Method for a Motor Vehicle

(75) Inventor: Leif Lindgren, Linkoping (SE)

(73) Assignee: AUTOLIV DEVELOPMENT AB, Vargarda (SE)

(21) Appl. No.: 13/265,896

(22) PCT Filed: May 5, 2010
(86) PCT No.: PCT/EP2010/002749

§ 371 Date: Oct. 24, 2011

(30) Foreign Application Priority Data
May 19, 2009 (EP) 09006736.4

(51) Int. Cl. H04N 7/18; H04N 15/00

(52) U.S. Cl. 348/47; 348/148; 348/E07.085; 348/E13.074

(57) ABSTRACT

A vision system (10) for a motor vehicle includes at least one imaging device (12) adapted to detect images from a region surrounding the motor vehicle, and an electronic processing means (14) for processing image data provided by the imaging device (12). The imaging device (12) includes an image sensor (21). The vision system (10) is adapted to input window parameters to the image sensor (21) for cutting out and outputting a window image part (32) of the complete image area (30) of the image sensor (21).

### CROSS REFERENCE TO RELATED APPLICATIONS

This application claims priority to European Patent Application No. 09006736.4, filed May 19, 2009 and PCT/EP2010/002749, filed May 5, 2010.

### TECHNICAL FIELD OF THE INVENTION

The invention relates to a vision system for a motor vehicle, comprising at least one imaging device adapted to detect images from a region surrounding the motor vehicle, and an electronic processing means for processing image data provided by said imaging device, wherein said imaging device comprises an image sensor. Furthermore, the invention relates to a corresponding vision method.

### BACKGROUND OF THE INVENTION

Such systems are generally known, see for example U.S. Pat. No. 7,158,664 B2. Due to the limited processing and memory resources in a motor vehicle a compromise between detection efficiency and costs has to be found.

### SUMMARY OF THE INVENTION

The object of the invention is to provide a reliable and cost-efficient vision system for a motor vehicle.

According to the invention, a window is cut out of the whole image area already in the image sensor of the imaging device and only the cut-out window is transmitted to the electronic (pre-)processing means for further image and data processing. Thereby the amount of data that needs to be transferred, processed and stored is reduced already at the start point of signal generation.

In the context of the present application, image sensor means the electronic device where the detected radiation is converted into an electric signal. The execution of the windowing already in the image sensor distinguishes the invention from the known use of image windows in image processing procedures performed behind the image sensor. Preferably the image sensor is an infrared sensor or a complementary metal-oxide-semiconductor device (CMOS device).

Preferably the window parameters are set individually depending on the relative orientation of the imaging device, i.e. the orientation of the imaging device relative to the vehicle or relative to another imaging device. This feature distinguishes the invention from cutting out a constant window arranged in the complete sensor area in-dependent of the orientation of the imaging device.

The individual setting of the window parameters depending on the relative orientation of the imaging device is particularly advantageous in the preferred application of the invention in a stereo vision system, usually including two imaging devices, like infrared cameras or CMOS cameras, each comprising an image sensor. In this application the window parameters are preferably set independently for every image sensor. The cutting-out of the individual image windows depending on the orientation of the corresponding imaging device may be regarded as a first step of aligning the stereo images relative to each other. In this manner, the aligning and matching process of the stereo images in the following electronic (pre-)processing means can be performed much faster and with less memory consumption.

Preferably the window parameters of the imaging device are set by the electronic processing means, rendering an additional parameter setting means unnecessary.

Preferably the vision system comprises a memory means for storing the window parameters, which allows to predetermine the window parameters in a measurement procedure and store them in the memory means in advance, for example by the vehicle manufacturer or a service station. Alternatively it is also possible to determine the window parameters during driving based on analysis of image data from the imaging means.

### BRIEF DESCRIPTION OF THE DRAWINGS

In the following the invention shall be illustrated on the basis of preferred embodiments with reference to the accompanying drawings, wherein:

FIG. 1 shows a schematic diagram of a vision system for a motor vehicle; and

FIG. 2 shows an example of stereo images detected by a stereo vision system.

### DETAILED DESCRIPTION OF THE DRAWINGS

The vision system 10 is mounted in a motor vehicle and comprises an imaging means 11 for detecting images of a region surrounding the motor vehicle, for example a region in front of the motor vehicle. Preferably the imaging means 11 is an infrared device and more preferably comprises one or more optical and/or infrared cameras 12a and 12b, where infrared covers near IR with wavelengths below 5 microns and/or far IR with wavelengths beyond 5 microns. Preferably the imaging means 11 comprises two cameras 12a and 12b forming a stereo imaging means 11; alternatively only one camera forming a mono imaging means can be used.

Each camera 12a and 12b comprises an optics arrangement 20a and 20b and a two-dimensional image sensor 21a and 21b, in particular an infrared sensor or an optical sensor, provided to convert incident infrared radiation or visible light transmitted through the camera 12a and 12b into an electrical signal containing image information of the detected scene.

The cameras 12a and 12b are coupled to an image pre-processor 13 adapted to control the capture of images by the cameras 12a and 12b, receive the electrical signal containing the image information from the image sensors 21a and 21b, warp pairs of left/right images into alignment and create disparity images, which per se is known in the art. The image pre-processor 13 may be realized by a dedicated hardware circuit. Alternatively the pre-processor 13, or part of its functions, can be realized in the electronic processing means 14.

The pre-processed image data is then provided to an electronic processing means 14 where further image and data processing is carried out by corresponding software. In particular, the image and data processing in the processing means 14 comprises the following functions: identification and classification of possible objects in front of the motor vehicle, such as other motor vehicles, pedestrians, bicyclists or large animals; tracking over time the position of identified object candidates in the detected images; activation or control of vehicle safety means 17, 18, and 19 depending on the result of the object detection and tracking processing.

The vehicle safety means 17, 18, and 19 may comprise a warning means 17 adapted to provide a collision warning to the driver by suitable optical, acoustical and/or haptical warning signals; display means 18 for displaying information relating to an identified object; one or more restraint systems 19 such as occupant airbags or safety belt tensioners; pedestrian airbags, hood lifters and the like; and/or dynamic vehicle control systems such as brakes.

The electronic processing means 14 expediently has access to a memory means 15.

The electronic processing means 14 is preferably programmed or programmable and may comprise a microprocessor or micro-controller. The image pre-processor 13, the electronic processing means 14 and the memory means 15 are preferably realized in an on-board electronic control unit (ECU) 16 and may be connected to the cameras 12a and 12b preferably via a separate cable or alternatively via a vehicle data bus. In another embodiment, the ECU and a camera 12a and 12b can be integrated into a single unit. All steps from imaging, image pre-processing, image processing to activation or control of safety means 17, 18, and 19 are performed automatically and continuously during driving in real time.

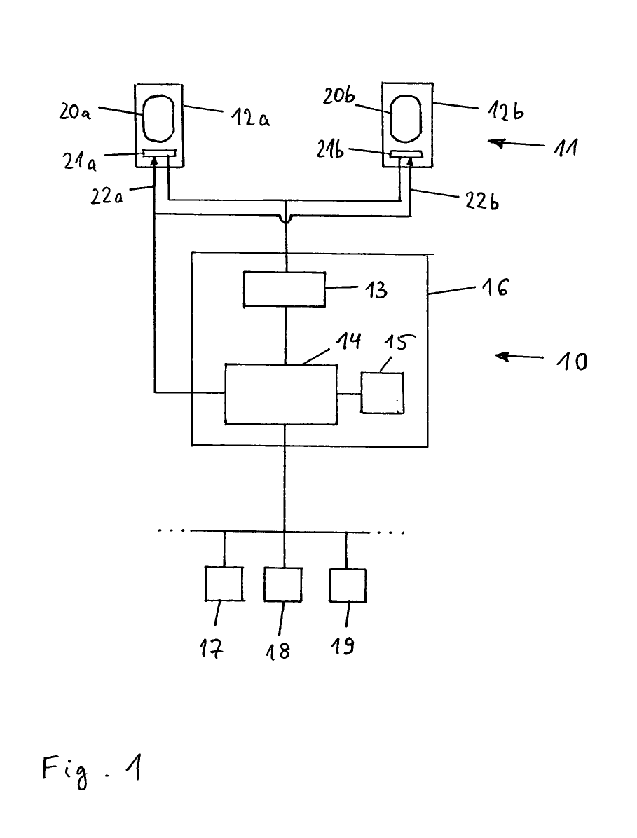

Each of the image sensors 21a and 21b comprises a window input 22a and 22b for specifying individual window parameters to each image sensor 21a and 21b. Preferably the window parameters are stored in the memory means 15 and transmitted to the image sensors 21a and 21b by the processing means 14, as shown in FIG. 1. However, it is also possible that the window parameters are transmitted to the image sensors 21a and 21b by the pre-processor 13 or another suited device in the electronic control unit 16.

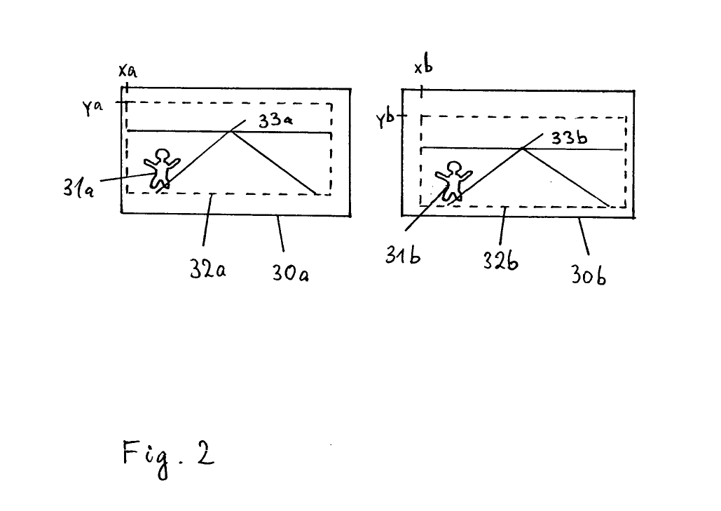

The process of cutting out individual window image parts of the complete image areas is explained using the exemplary images 30a and 30b shown in FIG. 2. Image 30a is assumed to have been detected by the camera 12a, where the image area 30a corresponds to the complete sensitive area, or entire sensor array, of the image sensor 21a. Similarly, image 30b is assumed to have been detected by the camera 12b, where the image area 30b corresponds to the complete sensitive area, or entire sensor array, of the image sensor 21b.

In the example of FIG. 2, the cameras 12a and 12b are slightly misaligned. In particular, the left camera 30a is slightly oriented off-center to the bottom right such that the contents of image 30a, for example the pedestrian image 31a, are slightly shifted to the top left, and the right camera 30b is slightly oriented off-center to the top left such that the contents of image 30b, for example the pedestrian image 31b, are slightly shifted to the bottom right.

If the whole image areas 30a and 30b are transmitted to the pre-processor 13, equal image contents appear at different positions in the stereo images 30a and 30b. For example the top of the pedestrian 31 appears several lines and columns earlier in the left image 30a than in the right image 30b. This leads to an enlarged latency and memory consumption for the stereo matching of the images 30a and 30b in the pre-processor 13. For example if the stereo matching is performed line by line in the pre-processor 13, the matching of the line containing the top of the pedestrian 31a in the left image 30a cannot be started until this line appears much later in the right image 30b, and all lines in between have to be buffered in memory.

According to the invention, smaller window image parts 32a and 32b are individually cut out of the whole image areas 30a and 30b in a manner that the image contents in the window image parts 32a and 32b are closely matching, in order to compensate for any misalignment of the cameras 12a and 12b. The windowing process is already performed in the image sensors 21a and 21b in order to benefit from reduced data amounts as early as possible; only a reduced amount of image data has to be transmitted from the cameras 12a and 12b to the electronic control unit 16 and stored therein.

The individual window parameters applied to the window input 22a and 22b of the image sensors 21a and 21b may for example comprise the x,y-coordinates of a predetermined point of the window area 32a and 32b (coordinates xa and ya, and xb and yb of the upper left window corner in FIG. 2). The window parameters applied to the window input 22a and 22b may also comprise information about the window size, such as number of rows and columns of the window. Alternatively the window size may be preset in the image sensors 21a and 21b.

Due to the above described windowing, equal image contents appear at approximately equal vertical positions in the window images 32a and 32b. This leads to reduced latency and memory consumption for the stereo matching of the window images 32a and 32b in the pre-processor 13. For example if the stereo matching is performed line by line in the pre-processor 13, the matching of the line containing the top of the pedestrian 31a in the left image window 32a can be started without large delay because this line appears in the right image window 32b at the same line or in any case with a much smaller line offset.

The window parameters to be applied to the image sensors 21a and 21b can be pre-determined for example by the vehicle manufacturer or a service station in a measuring procedure determining the alignment of the cameras 12a and 12b in the vehicle, and stored in the memory means 15 for use during driving. However, it is also possible to determine the alignment of the cameras 12a and 12b in the vehicle during driving, for example by determining an offset of a vanishing point 33a and 33b from the centre of the image area 30a and 30b, and calculate the individual window parameters from the determined (mis)alignment.

The foregoing description of various embodiments of the invention has been presented for purposes of illustration and description. It is not intended to be exhaustive or to limit the invention to the precise embodiments disclosed. Numerous modifications or variations are possible in light of the above teachings. The embodiments discussed were chosen and described to provide the best illustration of the principles of the invention and its practical application to thereby enable one of ordinary skill in the art to utilize the invention in various embodiments and with various modifications as are suited to the particular use contemplated. All such modifications and variations are with-in the scope of the invention as determined by the appended claims when interpreted in accordance with the breadth to which they are fairly, legally, and equitably entitled.

What is claimed is:

1. A vision system (10) for a motor vehicle, comprising:
at least one imaging device (12) in the form of an image sensor (21) adapted to detect images from a region surrounding the motor vehicle, and
electronic processing means (14) for processing image data provided by the imaging device (12),
the vision system (10) being configured to input window parameters to the image sensor (21) for cutting out and outputting a window image part (32) of the complete image area (30) of the image sensor (21).

2. The vision system according to claim 1, wherein the window parameters are set individually depending on a relative orientation of the imaging device (12).

3. The vision system according to claim 1, wherein the vision system (10) is a stereo vision system having two image sensors.

4. The vision system according to claim 1, wherein the at least one image sensor (12) is an infrared camera or a CMOS camera.

5. The vision system according to claim 1, wherein the image sensor (21) is an infrared sensor or a CMOS sensor.

6. The vision system according to claim 1, wherein the window parameters are input to the image sensor (21) by the electronic processing means (14).

7. The vision system according to claim 1, further comprising memory means (15) for storing the window parameters.

8. The vision system according to claim 7, wherein the window parameters are predetermined in a measurement procedure and stored in the memory means (15) in advance.

9. The vision system according to any claim 1, further comprising an image pre-processing device (13) adapted to pre-process windowed image data (32) provided by the image sensor (21).

10. The vision system according to claim 9, wherein the pre-processing device (13) is configured to warp the windowed image data (32) into alignment and to perform a subsequent stereo matching.

11. The vision system according to claim 1, wherein said the window parameters comprise coordinates of a specific image point of the window image part (32).

12. A vision method for a motor vehicle of the type having a vision system with at least one imaging device formed by an image sensor, and electronic processing means, the method comprising the following steps:
inputting window parameters to the image sensor;
detecting images from a region in front of the motor vehicle using the image sensor;
producing image data in the image sensor corresponding to a window image part defined by the window parameters;
supplying the image data corresponding to the window image part to the electronic processing means;
processing the image data in the electronic processing means.

13. The vision method according to claim 12, further comprising the step of individually adjusting the window parameters to compensate for a relative orientation of the imaging device in the vehicle.
